(19) United States
(12) Patent Application Publication
(10) Pub. No.: US 2015/0294372 A1
(43) Pub. Date: Oct. 15, 2015

(54) MANAGEMENT OF ALLOCATION OF ONLINE RESOURCES

(71) Applicant: eBay Inc., San Jose, CA (US)

(72) Inventor: Kane Sweeney, San Francisco, CA (US)

(21) Appl. No.: 14/579,606

(22) Filed: Dec. 22, 2014

Related U.S. Application Data
(60) Provisional application No. 61/979,381, filed on Apr. 14, 2014.

(51) Int. Cl. G06Q 30/02

(52) U.S. Cl. CPC G06Q 30/0275

(57) ABSTRACT

In some example embodiments, for each one of a plurality of advertisements, receiving a corresponding original bid for an online resource is received, with each one of the plurality of advertisements corresponding to a different advertiser. For each one of the plurality of advertisements, a corresponding handicap value is determined independent of the corresponding original bid. For each one of the plurality of advertisements, a corresponding effective bid for the online resource is determined based on the corresponding original bid and the corresponding handicap value. One of the plurality of advertisements is selected based on the effective bids of the plurality of advertisements. The selected one of the plurality of advertisements is assigned, in a database, to the online resource. The selected one of the plurality of advertisements is caused to be displayed on a computing device in response to a user-generated interrupt received from the computing device.

### CROSS-REFERENCE TO RELATED APPLICATIONS

This application claims the benefit of priority, under 35 U.S.C. Section 119(e), to U.S. Provisional Application No. 61/979,381, filed on Apr. 14, 2014, entitled, “AUCTION EXCHANGES FOR CANNIBALISTIC ADS”, which is hereby incorporated by reference in its entirety as if set forth herein.

### TECHNICAL FIELD

The present application relates generally to the technical field of data processing, and, in various embodiments, to systems and methods of management of allocation of online resources.

### BACKGROUND

Current solutions for allocating online resources, such as advertising slots or space, can suffer from ineffective allocation strategies that fail to take into account all of the preferences of an online entity.

### BRIEF DESCRIPTION OF THE DRAWINGS

Some embodiments of the present disclosure are illustrated by way of example and not limitation in the figures of the accompanying drawings, in which like reference numbers indicate similar elements, and in which:

FIG. 1 is a block diagram depicting a network architecture of a system having a client-server architecture configured for exchanging data over a network, in accordance with some embodiments;

FIG. 2 is a block diagram depicting various components of a network-based publication system, in accordance with some embodiments;

FIG. 3 is a block diagram depicting various tables that can be maintained within a database, in accordance with some embodiments;

FIG. 4 is a block diagram illustrating components of a resource allocation system, in accordance with some embodiments;

FIG. 5 illustrates different bids for an advertisement space, in accordance with some embodiments;

FIG. 6 is a flowchart illustrating a method of online resource allocation, in accordance with some embodiments;

FIGS. 7A-7C illustrate examples of the effect of employing the techniques disclosed herein, in accordance with some embodiments;

FIGS. 8A-8C illustrate examples of the effect of employing the techniques disclosed herein, in accordance with some embodiments;

FIG. 9 is a flowchart illustrating a method of online resource allocation, in accordance with some embodiments;

FIG. 10 is a flowchart illustrating a method of online resource allocation, in accordance with some embodiments;

FIG. 11 is a block diagram illustrating a mobile device, in accordance with some embodiments; and

FIG. 12 shows a diagrammatic representation of a machine in the example form of a computer system within which a set of instructions can be executed to cause the machine to perform any one or more of the methodologies discussed herein, in accordance with some embodiments.

### DETAILED DESCRIPTION

The description that follows includes illustrative systems, methods, techniques, instruction sequences, and computing machine program products that embody illustrative embodiments. In the following description, for purposes of explanation, numerous specific details are set forth in order to provide an understanding of various embodiments of the inventive subject matter. It will be evident, however, to those skilled in the art that embodiments of the inventive subject matter can be practiced without these specific details. In general, well-known instruction instances, protocols, structures, and techniques have not been shown in detail.

In some example embodiments, for each one of a plurality of advertisements, receiving a corresponding original bid for an online resource is received, with each one of the plurality of advertisements corresponding to a different advertiser. For each one of the plurality of advertisements, a corresponding handicap value is determined independent of the corresponding original bid. For each one of the plurality of advertisements, a corresponding effective bid for the online resource is determined based on the corresponding original bid and the corresponding handicap value. One of the plurality of advertisements is selected based on the effective bids of the plurality of advertisements. The selected one of the plurality of advertisements is assigned, in a database, to the online resource. The selected one of the plurality of advertisements is caused to be displayed on a computing device in response to a user-generated interrupt received from the computing device.

In some example embodiments, corresponding handicap values for each of a plurality of categories of advertisements are determined, with the determining of the corresponding handicap values comprising performing a machine learning process on advertising information and sales information of a website to determine an effect of advertisements of each one of the plurality of categories on sales of items offered for sale on the website. The handicap values are stored in the database in association with their corresponding categories. In some example embodiments, determining the corresponding handicap values for each one of the plurality of advertisements comprises, for each one of the plurality of advertisements, determining a corresponding category, and, for each one of the plurality of advertisements, determining the corresponding handicap value based on a match between the determined category and one of the stored categories.

In some example embodiments, the online resource comprises a single defined advertisement space on a webpage, and causing the selected one of the plurality of advertisements to be displayed on the computing device comprises causing the selected one of the plurality of advertisements to be displayed in the single advertisement space on the webpage.

In some example embodiments, the assigning comprises ranking the plurality of advertisements based on their corresponding effective bids, determining a highest ranking advertisement of the plurality of advertisements, and assigning the selected one of the plurality of advertisements to the online resource based on a determination that the selected on is the highest ranking advertisement. In some example embodiments, a second highest ranking advertisement of the plurality of advertisements can be determined, a payment price for the online resource can be determined based on the corresponding effective bid of the second highest ranking advertisement and the corresponding handicap value of the selected one of the plurality of advertisements, and the payment price is assigned, in the database, to the corresponding advertiser of the selected one of the plurality of advertisements. In some example embodiments, determining the payment price comprises calculating the sum of the corresponding effective bid of the second highest ranking advertisement and the corresponding handicap value of the selected one of the plurality of advertisements.

In some example embodiments, each effective bid is determined based on a subtraction of the corresponding handicap value from the corresponding original bid.

The methods or embodiments disclosed herein can be implemented as a computer system having one or more modules (e.g., hardware modules or software modules). Such modules can be executed by one or more processors of the computer system. The methods or embodiments disclosed herein can be embodied as instructions stored on a machine-readable medium that, when executed by one or more processors, cause the one or more processors to perform the instructions.

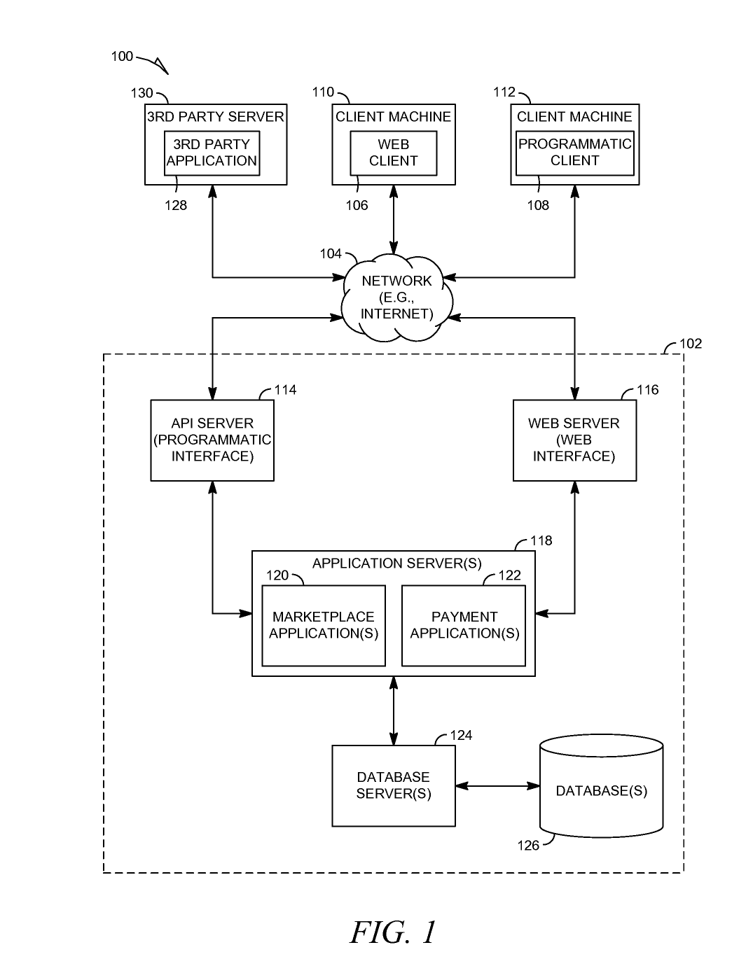

FIG. 1 is a network diagram depicting a client-server system 100, within which one example embodiment can be deployed. A networked system 102, in the example forms of a network-based marketplace or publication system, provides server-side functionality, via a network 104 (e.g., the Internet or a Wide Area Network (WAN)) to one or more clients. FIG. 1 illustrates, for example, a web client 106 (e.g., a browser, such as the Internet Explorer browser developed by Microsoft Corporation of Redmond, Wash. State) and a programmatic client 108 executing on respective client machines 110 and 112.

An API server 114 and a web server 116 are coupled to, and provide programmatic and web interfaces respectively to, one or more application servers 118. The application servers 118 host one or more marketplace applications 120 and payment applications 122. The application servers 118 are, in turn, shown to be coupled to one or more database servers 124 that facilitate access to one or more databases 126.

The marketplace applications 120 can provide a number of marketplace functions and services to users who access the networked system 102. The payment applications 122 can likewise provide a number of payment services and functions to users. The payment applications 122 can allow users to accumulate value (e.g., in a commercial currency, such as the U.S. dollar, or a proprietary currency, such as “points”) in accounts, and then later to redeem the accumulated value for products (e.g., goods or services) that are made available via the marketplace applications 120. While the marketplace and payment applications 120 and 122 are shown in FIG. 1 to both form part of the networked system 102, it will be appreciated that, in alternative embodiments, the payment applications 122 can form part of a payment service that is separate and distinct from the networked system 102.

Further, while the system 100 shown in FIG. 1 employs a client-server architecture, the embodiments are, of course not limited to such an architecture, and could equally well find application in a distributed, or peer-to-peer, architecture system, for example. The various marketplace and payment applications 120 and 122 could also be implemented as standalone software programs, which do not necessarily have networking capabilities.

The web client 106 accesses the various marketplace and payment applications 120 and 122 via the web interface supported by the web server 116. Similarly, the programmatic client 108 accesses the various services and functions provided by the marketplace and payment applications 120 and 122 via the programmatic interface provided by the API server 114. The programmatic client 108 can, for example, be a seller application (e.g., the TurboLister application developed by eBay Inc., of San Jose, Calif.) to enable sellers to author and manage listings on the networked system 102 in an off-line manner, and to perform batch-mode communications between the programmatic client 108 and the networked system 102.

FIG. 1 also illustrates a third party application 128, executing on a third party server machine 130, as having programmatic access to the networked system 102 via the programmatic interface provided by the API server 114. For example, the third party application 128 can, utilizing information retrieved from the networked system 102, support one or more features or functions on a website hosted by the third party. The third party website can, for example, provide one or more promotional, marketplace, or payment functions that are supported by the relevant applications of the networked system 102.

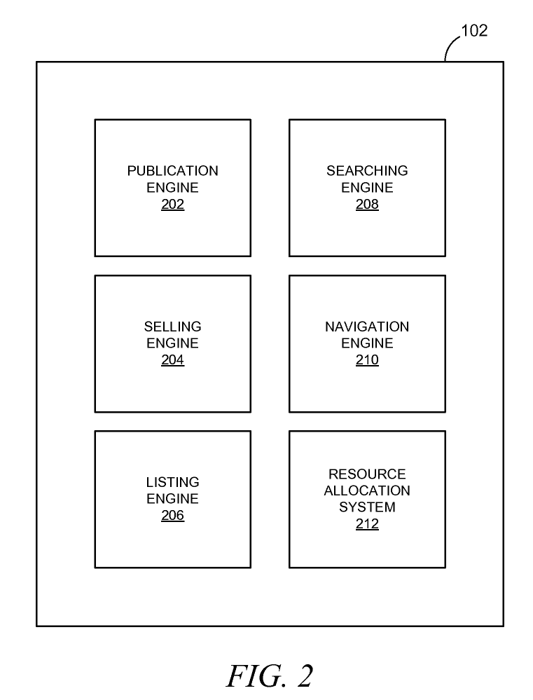

FIG. 2 illustrates a block diagram showing components provided within the networked system 102 according to some embodiments. The networked system 102 can be hosted on dedicated or shared server machines (not shown) that are communicatively coupled to enable communications between server machines. The components themselves are communicatively coupled (e.g., via appropriate interfaces) to each other and to various data sources, so as to allow information to be passed between the applications or so as to allow the applications to share and access common data. Furthermore, the components can access one or more databases 126 via the database servers 124.

The networked system 102 can provide a number of publishing, listing, and/or price-setting mechanisms whereby a seller (also referred to as a first user) can list (or publish information concerning) goods or services for sale or barter, a buyer (also referred to as a second user) can express interest in or indicate a desire to purchase or barter such goods or services, and a transaction (such as a trade) can be completed pertaining to the goods or services. To this end, the networked system 102 can comprise at least one publication engine 202 and one or more selling engines 204. The publication engine 202 can publish information, such as item listings or product description pages, on the networked system 102. In some embodiments, the selling engines 204 can comprise one or more fixed-price engines that support fixed-price listing and price setting mechanisms and one or more auction engines that support auction-format listing and price setting mechanisms (e.g., English, Dutch, Chinese, Double, Reverse auctions, etc.). The various auction engines can also provide a number of features in support of these auction-format listings, such as a reserve price feature whereby a seller can specify a reserve price in connection with a listing and a proxy-bidding feature whereby a bidder can invoke automated proxy bidding. The selling engines 204 can further comprise one or more deal engines that support merchant-generated offers for products and services.

A listing engine 206 allows sellers to conveniently author listings of items or authors to author publications. In one embodiment, the listings pertain to goods or services that a user (e.g., a seller) wishes to transact via the networked system 102. In some embodiments, the listings can be an offer, deal, coupon, or discount for the good or service. Each good or service is associated with a particular category. The listing engine 206 can receive listing data such as title, description, and aspect name/value pairs. Furthermore, each listing for a good or service can be assigned an item identifier. In other embodiments, a user can create a listing that is an advertisement or other form of information publication. The listing information can then be stored to one or more storage devices coupled to the networked system 102 (e.g., databases 126). Listings also can comprise product description pages that display a product and information (e.g., product title, specifications, and reviews) associated with the product. In some embodiments, the product description page can include an aggregation of item listings that correspond to the product described on the product description page.

The listing engine 206 can also allow buyers to conveniently author listings or requests for items desired to be purchased. In some embodiments, the listings can pertain to goods or services that a user (e.g., a buyer) wishes to transact via the networked system 102. Each good or service is associated with a particular category. The listing engine 206 can receive as much or as little listing data, such as title, description, and aspect name/value pairs, that the buyer is aware of about the requested item. In some embodiments, the listing engine 206 can parse the buyer's submitted item information and can complete incomplete portions of the listing. For example, if the buyer provides a brief description of a requested item, the listing engine 206 can parse the description, extract key terms and use those terms to make a determination of the identity of the item. Using the determined item identity, the listing engine 206 can retrieve additional item details for inclusion in the buyer item request. In some embodiments, the listing engine 206 can assign an item identifier to each listing for a good or service.

In some embodiments, the listing engine 206 allows sellers to generate offers for discounts on products or services. The listing engine 206 can receive listing data, such as the product or service being offered, a price and/or discount for the product or service, a time period for which the offer is valid, and so forth. In some embodiments, the listing engine 206 permits sellers to generate offers from the sellers' mobile devices. The generated offers can be uploaded to the networked system 102 for storage and tracking.

Searching the networked system 102 is facilitated by a searching engine 208. For example, the searching engine 208 enables keyword queries of listings published via the networked system 102. In example embodiments, the searching engine 208 receives the keyword queries from a device of a user and conducts a review of the storage device storing the listing information. The review will enable compilation of a result set of listings that can be sorted and returned to the client device (e.g., device machine 110, 112) of the user. The searching engine 208 can record the query (e.g., keywords) and any subsequent user actions and behaviors (e.g., navigations).

The searching engine 208 also can perform a search based on the location of the user. A user can access the searching engine 208 via a mobile device and generate a search query. Using the search query and the user's location, the searching engine 208 can return relevant search results for products, services, offers, auctions, and so forth to the user. The searching engine 208 can identify relevant search results both in a list form and graphically on a map. Selection of a graphical indicator on the map can provide additional details regarding the selected search result. In some embodiments, the user can specify as part of the search query a radius or distance from the user's current location to limit search results.

The searching engine 208 also can perform a search based on an image. The image can be taken from a camera or imaging component of a client device or can be accessed from storage.

In a further example, a navigation engine 210 allows users to navigate through various categories, catalogs, or inventory data structures according to which listings can be classified within the networked system 102. For example, the navigation engine 210 allows a user to successively navigate down a category tree comprising a hierarchy of categories (e.g., the category tree structure) until a particular set of listings is reached. Various other navigation applications within the navigation engine 210 can be provided to supplement the searching and browsing applications. The navigation engine 210 can record the various user actions (e.g., clicks) performed by the user in order to navigate down the category tree.

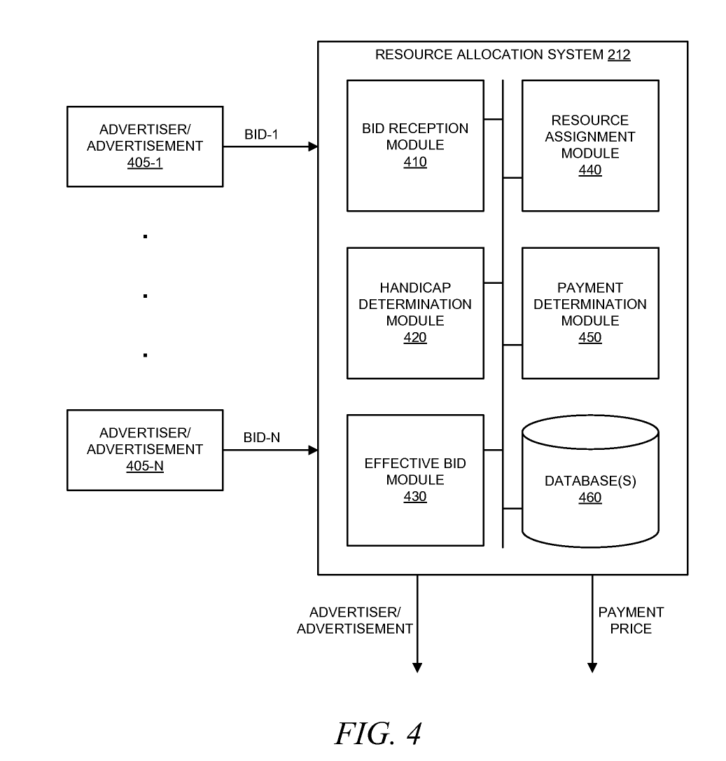

In some embodiments, a resource allocation system 212 can be configured to assign resources on a webpage, such as assigning advertisements to advertising space on the web page. The features, functions, and operations of the resource allocation system 212 will be discussed in further detail below with respect to FIGS. 4-8C.

Additional modules and engines associated with the networked system 102 are described below in further detail. It should be appreciated that modules or engines can embody various aspects of the details described below.

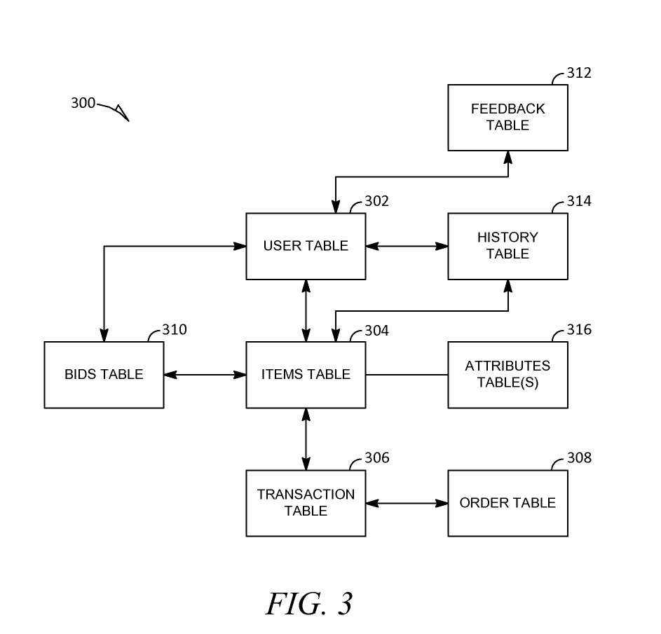

FIG. 3 is a high-level entity-relationship diagram, illustrating various tables 300 that can be maintained within the database(s) 126, and that are utilized by and support the applications 120 and 122. A user table 302 contains a record for each registered user of the networked system 102, and can include identifier, address and financial instrument information pertaining to each such registered user. A user can operate as a seller, a buyer, or both, within the networked system 102. In one example embodiment, a buyer can be a user that has accumulated value (e.g., commercial or proprietary currency), and is accordingly able to exchange the accumulated value for items that are offered for sale by the networked system 102.

The tables 300 also include an items table 304 in which are maintained item records for goods and services that are available to be, or have been, transacted via the networked system 102. Each item record within the items table 304 can furthermore be linked to one or more user records within the user table 302, so as to associate a seller and one or more actual or potential buyers with each item record.

A transaction table 306 contains a record for each transaction (e.g., a purchase or sale transaction) pertaining to items for which records exist within the items table 304.

An order table 308 is populated with order records, with each order record being associated with an order. Each order, in turn, can be associated with one or more transactions for which records exist within the transaction table 306.

Bid records within a bids table 310 each relate to a bid received at the networked system 102 in connection with an auction-format listing supported by an auction application. A feedback table 312 is utilized by one or more reputation applications, in one example embodiment, to construct and maintain reputation information concerning users. A history table 314 maintains a history of transactions to which a user has been a party. One or more attributes tables 316 record attribute information pertaining to items for which records exist within the items table 304. Considering only a single example of such an attribute, the attributes tables 316 can indicate a currency attribute associated with a particular item, with the currency attribute identifying the currency of a price for the relevant item as specified by a seller.

The present disclosure provides techniques for managing the allocation of online resources for an online entity, such as the allocation of advertising space (e.g., slots) on a page of a website to an advertisement. More specifically, the present disclosure provides a system and method for assigning advertisements to web pages in an auction exchange. Although the examples discussed herein are directed towards the allocation of advertising space on a page of a website to an advertisement, it is contemplated that other online resources and other online entities are also within the scope of the present disclosure.

Unlike existing auction methods, which simply award an ad slot to the highest bidder (modulo a reserve price), the techniques of the present disclosure allow the publisher (e.g., seller of ad space) to flexibly state preferences over the type of advertiser shown. As an example, some ads shown on retail platforms (e.g., eBay.com®, Amazon.com®, etc.) can cannibalize the platforms' “organic” sales. The method of the present disclosure respects the newly-stated preferences of the supply side (e.g., the publisher). Importantly, these new preferences are not simply “reserve prices” as most commonly used in practice.

Publishers and platforms (e.g., eBay.com®, Bestbuy.com®, Amazon.com®) are increasingly showing third-party advertisements. In one example, a T-Mobile® ad can be shown on eBay.com®. The ad can be displayed along the right hand side of a page, and can be shown to a user that just searched for “iphone 4”. In this example, T-Mobile® has won this ad placement via an auction on an advertising exchange. In this example, eBay's main source of profit is generated from sales of the iPhones® on its website. However, T-Mobile® is offering, via the ad, a substitute product at a competitive price. Suppose that T-Mobile paid eBay.com a price of $2 for this ad slot. Suppose also that Geico® is willing to pay $1 for the ad slot. It is plausible that eBay.com® may prefer to show the Geico® ad for $1 than to show T-Mobile® ad for $2. The reason is simple: Geico® is less likely to cannibalize iPhone® sales than is T-Mobile®, since Geico® sells insurance, not cell phones. This preference by eBay.com® cannot be effectively communicated to the existing advertising exchanges (i.e., the ones that have contracted directly with T-Mobile®), and thus cannot be respected by the existing auction protocols.

In the iPhone 4 example above, cannibalization may also be important even between advertisers in the same category, such as Geico® and State Farm®, both insurance sellers. If the Geico® ad is more appealing (visually or otherwise) to platform users, then the State Farm® ad may be more cannibalistic in that it causes an inferior user experience for the platform (e.g., the website on which the ad will be displayed) as a whole, which may lead directly or indirectly to lower organic sales for the platform.

The present disclosure provides allocation solutions that accommodate publisher's (e.g., eBay.com) preferences. Features for matching advertisers to publishers are disclosed herein. To contrast with prior solutions, the process generally used is described herein. One distinction is that the prior solutions involve a classic one-sided bidding model (e.g., advertisers bid for inventory), while the protocol of the present disclosure effectively allows for two-sided bidding.

In the present disclosure, the terms “advertiser” and “bidder” can be used interchangeably. In some embodiments, at the time of the auction for an advertisement space, there are K advertisers vying for the publisher's ad slot. For simplicity, a model that abstracts away from reserve prices, bidder types, ad slot characteristics, etc. is outlined.

In the existing protocol:

1. Each bidder k in {1, . . . , K} submits a bid bₖ.

2. If bⱼ>max_{k≠j} {bₖ}, then

2.1. Bidder j wins the auction and is allocated the ad slot.

2.2. Bidder j pays the publisher maxₖⱼ {bₖ}.

For instance, if the bidders are indexed by the rank of their bid so that b₁, >b₂>b₃ . . . >, b_{K}, then bidder 1 wins and pays b₂. If several bidders have the same maximal bid, then select any one of those bidders at random and the selected bidder pays his bid.

In the protocol of the present disclosure:

1. The publisher establishes K+1 parameters R₀, R₁, . . . R_{K}.

2. Each bidder k in {1, . . . , K} submits a bid bₖ.

3. For each bidder k, compute the new adjusted bid b′ₖ=bₖ+Rₖ.

4. If R₀≧max {b′1, . . . , K}:

4.1. None of the bidders are allocated the ad slot.

5. If R₀<max {b′₁, . . . , b′_{K}}:

5.1. If b′ⱼ>max {R₀, max_{k≠j} {b′ₖ}}, then

5.1.1. Bidder j wins the auction and is allocated the ad slot

5.1.2. Bidder j pays the publisher max {R₀−Rⱼ, max_{k≠j} {b′ₖ−Rⱼ}}

If R₀=R₁= . . . =R_{K}=0, then the protocol of the present disclosure subsumes the prior protocol as a special case. The payment that the winning bidder makes can be thought of as the minimum bid such that the bidder is still guaranteed to win. An alternative payment rule can add some small increment. For example, step 5.1.2 can be adapted so that the payment is the max {R₀−Rⱼ+0.01, max_{k≠j} {b′ₖ−Rⱼ+0.01}}. If there are several bidders having the same maximal adjusted bids, one winner of those bidders, say bidder j, can be selected at random, and the protocol can continue to step 5.1.1.

FIG. 4 is a block diagram illustrating components of a resource allocation system 212, in accordance with some embodiments. In some embodiments, resource allocation system 212 comprises a special-purpose bid reception module 410, a special-purpose handicap determination module 420, a special-purpose effective bid module 430, a special-purpose resource assignment module 440, a special-purpose payment determination module 450, and one or more database(s) 460.

The bid reception module 410 can be configured to receive, for each one of a plurality of advertisers or advertisements 405-1 to 405-N, a corresponding original bid (bid-1 to bid-N) for an advertisement space on a website. The original bids can comprise monetary amounts. In some embodiments, the bid reception module 410 presents a user interface to advertisers. The advertisers can use the user interface to submit their corresponding bids.

The handicap determination module 420 can be configured to determine, for each one of the plurality of advertisements, a corresponding handicap value. The handicap values can be the parameters R₀, R₁, . . . R_{K} referred to herein. Each handicap value can correspond to the degree to which its corresponding advertiser/advertisement is likely to cannibalize organic sales of the website of the advertisement space. These handicap values can be predetermined and stored in the database(s) 460. In some embodiments, handicap values can be stored for any combination of one or more of an advertiser, a category of advertisers, an advertisement, a category of advertisements, a keyword or query, a category of keywords or queries, a user or consumer, a category of users or consumers, and a particular page of the platform (e.g., home page, payment confirmation page, etc.). For example, for each query (e.g., iPhone 4) or general category of queries (e.g., smartphones), handicap values can be assigned to each type or category of advertiser (e.g., smartphone advertisers, insurance advertisers, restaurant advertisers, etc.). The handicap values can be based on machine learning and a history of how much the corresponding ad or ad category has cannibalized sales. As previously mentioned, handicap values can be tailored for a specific user or a specific type of user. For example, one user might be more prone to clicking on an advertisement link and leaving the website than another user. Accordingly, different handicap values can be assigned to the same advertisement or advertiser for different users or user types. The handicap value of an ad can be determined based on a measure of how likely the ad is to have a negative effect on sales, whether the negative effect is from users choosing the ad over organic sales listings on the platform or from users leaving the platform due to the unappealing nature of the ad.

In some example embodiments, corresponding handicap values for each of a plurality of categories of advertisements are determined, with the determining of the corresponding handicap values comprising performing a machine learning process on advertising information and sales information of a website to determine an effect of advertisements of each one of the plurality of categories on sales of items offered for sale on the website. The handicap values can be stored in the database(s) 460 in association with their corresponding categories. In some example embodiments, determining the corresponding handicap values for each one of the plurality of advertisements 405 comprises, for each one of the plurality of advertisements 405, determining a corresponding category, and, for each one of the plurality of advertisements 405, determining the corresponding handicap value based on a match between the determined category and one of the stored categories. It is contemplated that this same approach of matching to determine the corresponding handicap values can be applied using the other factors discussed above for handicap values, including, but not limited to, an identification of an advertiser, a category of advertisers, an identification of an advertisement, a keyword or query, a category of keywords or queries, an identification of a user or consumer, a category of users or consumers, and a particular page of the platform.

The effective bid module 430 can be configured to determine, for each one of the plurality of advertisers/advertisements 405-1 to 405-N, a corresponding effective bid for the advertisement space based on the corresponding original bid and the corresponding handicap value. In some embodiments, determining the effective bid comprises adjusting the original bid using the handicap value, such as by subtracting the handicap value from the original bid.

The resource assignment module 440 can be configured to assign, in a database (e.g., database(s) 460 in FIG. 4), one of the plurality of advertisers/advertisements 405-1 to 405-N to the advertisement space based on the effective bids of the plurality of advertisers/advertisements 405-1 to 405-N. In some embodiments, the advertisers/advertisements 405-1 to 405-N are ranked based on their corresponding effective bids and the advertiser/advertisement with the highest effective bid is determined to be the winner of the advertisement space, and the winner is assigned, in the database, the advertisement space. The corresponding advertisement of the winner can then be displayed in the advertisement space.

The payment determination module 450 can be configured to determine a payment price for the advertisement space based on the effective bid of a determined runner-up of the plurality of advertisers/advertisements (e.g., the advertiser/advertisement with the second highest effective bid) and the handicap value of the advertiser/advertisement assigned to the advertisement space. For example, the payment determination module 450 can determine the payment price for the advertisement space by calculating the sum of the effective bid of the runner-up and the handicap value of the advertiser/advertisement assigned to the advertisement space, and the sum can be used as the payment price.

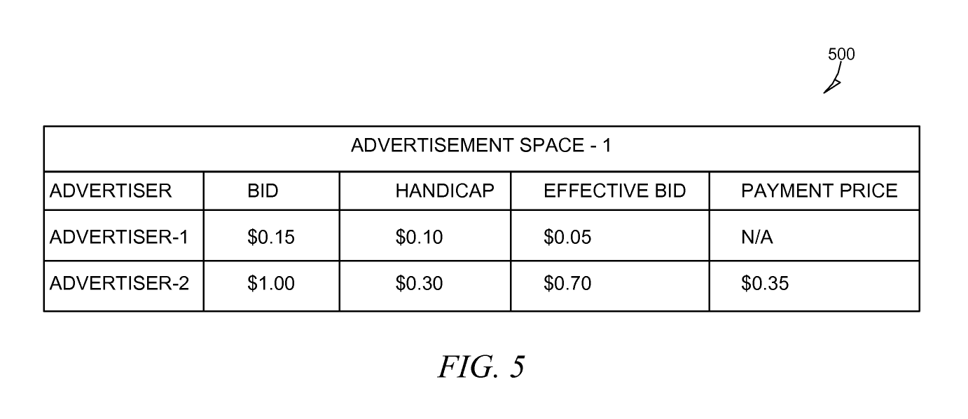

FIG. 5 illustrates a table 500 of different bids for an advertisement space (Advertisement Space-1), in accordance with some embodiments. Advertiser-1 has bid $0.15 for the advertisement space, while Advertiser-2 has bid $1.00 for the advertisement space. Advertiser-1 has a handicap value of $0.10 (reflecting a low degree of cannibalization of organic sales), while Advertiser-2 has a handicap value of $0.30 (reflecting a higher degree of cannibalization of organic sales than Advertiser-1). The effective bid for Advertiser-1 is $0.05 ($0.15−$0.10=$0.05), while the effective bid for Advertiser-2 is $0.70 ($1.00−$0.30=$0.70). Since Advertiser-2 has the highest effective bid, Advertiser-2 is determined to be the winner and is assigned the advertisement space. It is determined that Advertiser-2 will pay a payment price of $0.35 for the advertisement space. This payment price is calculated by taking the effective bid ($0.05) of the advertiser having the second highest effective bid (in this example, Advertiser-1) and adding the handicap value ($0.30) of the winner (Advertiser-2).

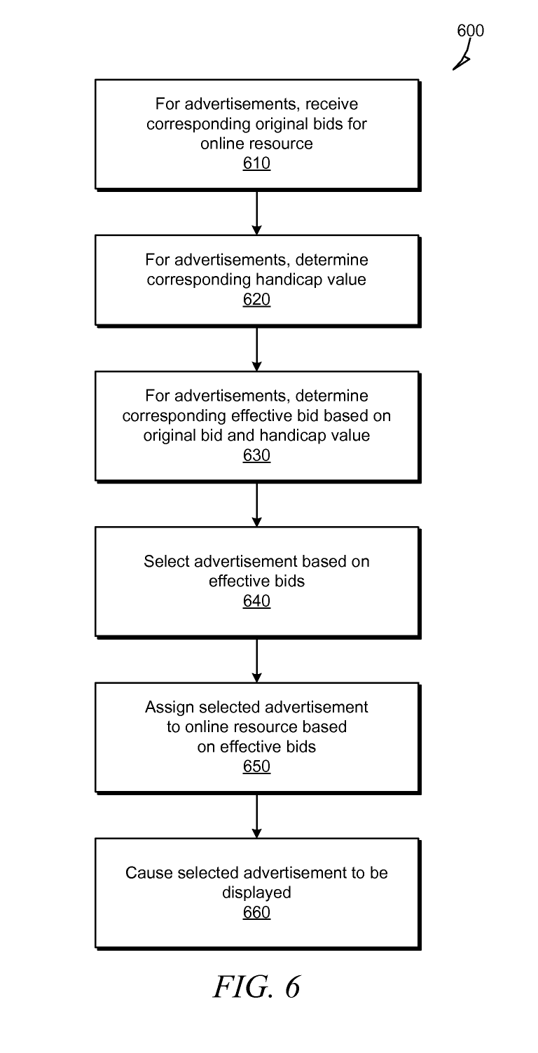

FIG. 6 is a flowchart illustrating a method 600 of determining an advertisement for an advertisement space, in accordance with some embodiments. The operations of method 600 can be performed by a system or modules of a system. The operations of method 600 can be performed by processing logic that can comprise hardware (e.g., circuitry, dedicated logic, programmable logic, microcode, etc.), software (e.g., instructions run on a processing device), or a combination thereof. In one example embodiment, the method 600 is performed by the resource allocation system 212 of FIGS. 2 and 4, or any combination of one or more of its components or modules, as described above.

At operation 610, for each one of a plurality of advertisements, receiving a corresponding original bid for an online resource is received, with each one of the plurality of advertisements corresponding to a different advertiser. In some example embodiments, the online resource comprises a single defined advertisement space on a webpage.

At operation 620, for each one of the plurality of advertisements, a corresponding handicap value is determined independent of the corresponding original bid.

At operation 630, for each one of the plurality of advertisements, a corresponding effective bid for the online resource is determined based on the corresponding original bid and the corresponding handicap value. In some example embodiments, each effective bid is determined based on a subtraction of the corresponding handicap value from the corresponding original bid.

At operation 640, one of the plurality of advertisements is selected based on the effective bids of the plurality of advertisements. In some example embodiments, the advertisement with the highest effective bid is selected.

At operation 650, the selected one of the plurality of advertisements is assigned, in a database, to the online resource.

At operation 660, the selected one of the plurality of advertisements is caused to be displayed on a computing device in response to a user-generated interrupt received from the computing device. The user-generated interrupt can correspond to a user on the computing device navigating to a particular page of a website corresponding to the online resource, such as a defined advertising space on the website. In some example embodiments, causing the selected one of the plurality of advertisements to be displayed on the computing device comprises causing the selected one of the plurality of advertisements to be displayed in a single advertisement space on a webpage.

It is contemplated that the operations of method 600 can incorporate any of the other features disclosed herein.

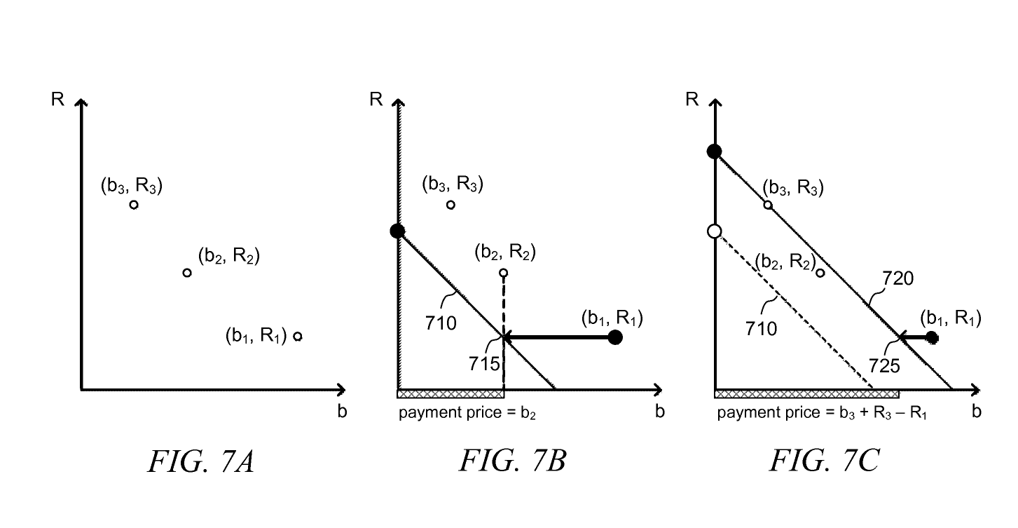

FIGS. 7A-7C illustrate examples of the effect of employing the techniques disclosed herein, in accordance with some embodiments. FIGS. 7A-7C illustrate the comparative advantage of the proposed protocol over the existing protocol. In FIGS. 7A-7C, there are three advertisers (Advertiser 1, Advertiser 2, and Advertiser 3) bidding for one ad slot. The y-plot represents the organic revenue R from the corresponding ad in the ad slot, while the x-plot represents the bid value (or value to the bidder) b of the ad slot.

As seen in FIG. 7A, Advertiser 1 submits a bid of b₁, Advertiser 2, submits a bid of b₂, and Advertiser 3 submits a bid of b₃. Plot point (b₁, R₁) shows the relationship between bid b₁ and the corresponding organic revenue R₁, plot point (b₂, R₂) shows the relationship between bid b₂ and the corresponding organic revenue R₂, and plot point (b₃, R₃) shows the relationship between bid b3 and the corresponding organic revenue R₃.

In order to maximize the efficiency of the bidding system, the technique of the present disclosure maximizes the sum of the organic revenue and the bid value. In FIG. 7B, the sum can be represented by the distance from the origin (0,0) to the −45° line 710. Using the prior method, the advertiser simply having the highest original bid is assigned as the winner of the auction for the slot and pays an amount just enough to beat the next highest bid, represented by point 715. In FIG. 7B, the Advertiser 1 wins the auction for the ad slot with bid b₁, but winds up paying b₂ for the ad slot.

In contrast, using the method of the present disclosure, as shown in FIG. 7C, Advertiser 1 still wins the auction for the ad slot with bid b₁. However, here the handicap of Advertiser 1 is taken into account when determining the payment price, thereby resulting in a payment price of b₃+R₃−R₁, represented by point 725. The resulting sum can be represented by the distance from the origin (0,0) to the −45° line 720, which is greater than the distance resulting from the use of the old method in FIG. 7B.

If Advertiser 1 is assigned the ad slot and pays the publisher p, the profit to the publisher is p+R₁. R₂ and R₃ are defined similarly and can be thought of as the publisher's profit from channels other than payments from advertisers. This is illustrated in FIGS. 7A-7C. It is noted that Advertiser 1, represented by (b₁,R₁), wins both the auctions, whether using the prior method or the method of the present disclosure. However, Advertiser 1's payment to the publisher is higher in the auction using the method of the present disclosure.

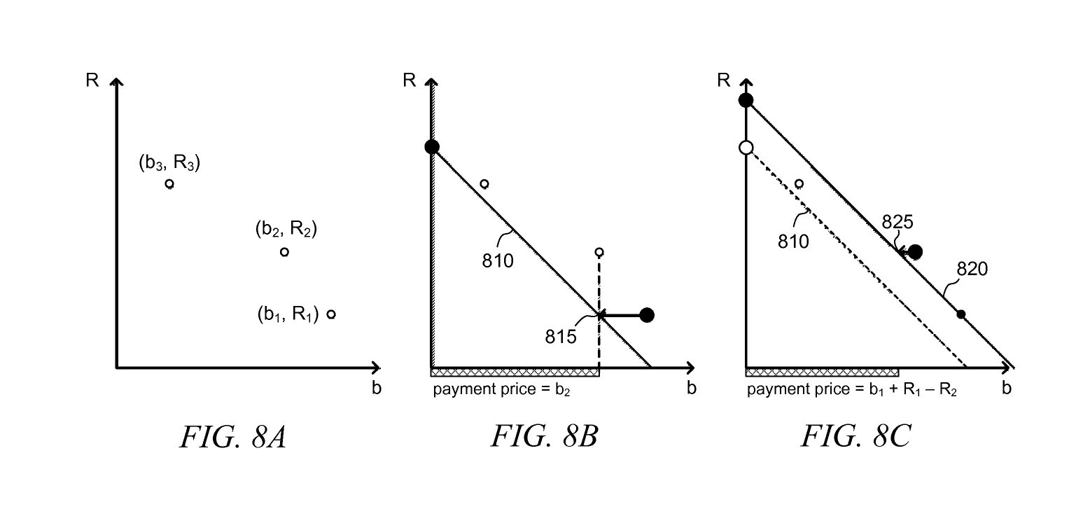

FIGS. 8A-8C depict a similar example as in FIGS. 7A-7C, but illustrate two additional key points: (i) the winning advertiser can be different under the prior method and method of the present disclosure and (ii) the payment to the publisher can be lower under the method of the present disclosure than under the prior method.

In FIGS. 8A-8C, there are three advertisers (Advertiser 1, Advertiser 2, and Advertiser 3) bidding for one ad slot. The y-plot represents the organic revenue R from the corresponding ad in the ad slot, while the x-plot represents the bid value (or value to the bidder) b of the ad slot.

As seen in FIG. 8A, Advertiser 1 submits a bid of b₁, Advertiser 2, submits a bid of b₂, and Advertiser 3 submits a bid of b₃. Plot point (b₁, R₁) shows the relationship between bid b₁ and the corresponding organic revenue R₁, plot point (b₂, R₂) shows the relationship between bid b₂ and the corresponding organic revenue R₂, and plot point (b₃, R₃) shows the relationship between bid b₃ and the corresponding organic revenue R₃.

In FIG. 8B, the sum of the organic revenue and the bid value can be represented by the distance from the origin (0,0) to the −45° line 810. Using the prior method, the advertiser simply having the highest original bid is assigned as the winner of the auction for the slot and pays an amount just enough to beat the next highest bid, represented by point 815. In FIG. 8B, the Advertiser 1 wins the auction for the ad slot with bid b₁, but winds up paying b₂ for the ad slot.

Using the method of the present disclosure, as shown in FIG. 8C, Advertiser 2 wins the auction for the ad slot with bid b₂, instead of Advertiser 1, as the use of the handicaps change the winner. Although the original bid of Advertiser 1 is greater than the original bid of Advertiser 2, the effective bid of Advertiser 2 is greater than the effective bid of Advertiser 1. The handicap value is also used to determine the payment price of b₁+R₁−R₂, represented by point 825. The resulting sum can be represented by the distance from the origin (0,0) to the −45° line 820, which is greater than the distance resulting from the use of the old method in FIG. 8B.

The allocation protocol of the present disclosure can be adapted to accommodate reserve prices (r₁, . . . , r_{K}) that are specific to each bidder. For example, a proposed protocol with reserves can include the following:

1. The publisher establishes 2K+1 parameters R₀, R₁, . . . R_{K}, r₁, . . . , r_{K}.

2. Each bidder k in {1, . . . , K} submits a bid bₖ.

3. For each bidder k, compute the new adjusted bid b′ₖ=bₖ+Rₖ.

4. If R₀≧max {b′₁, . . . , b′_{K}}:

4.1 None of the bidders are allocated the ad slot.

5. If R₀<max {b′₁, . . . , b′_{K}}:

5.1 If b′ⱼ>max {R0, max_{k≠j} {b′ₖ}, rⱼ+Rⱼ}, then

5.1.1 Bidder j wins the auction and is allocated the ad slot

5.1.2 Bidder j pays the publisher max {R₀−Rⱼ, max_{k≠j} {b′ₖ−Rⱼ}, rⱼ}

5.2 If b′ⱼ=rⱼ+Rⱼ>max {R0, max_{k≠j} {b′ₖ}}, then

5.2.1 Bidder j wins the auction and is allocated the ad slot

5.2.2 Bidder j pays the publisher rⱼ.

In some embodiments, each advertiser can be categorized with a “type” and the publisher of the ad slot can be enabled or allowed to set R and r parameters for each type. For example, eBay.com® can set parameter values to be the same for all the telecommunication companies and also set the parameter values to be the same for all insurance companies.

The techniques and protocols are described as if there is a single slot to be sold. However, it is contemplated that the parameters and bids can vary according to various characteristics, such as the exact placement on the publisher's site, date and time, attributes of the target audience, etc. These are also easily accommodated by allowing the bids and parameters to vary along these dimensions. In some embodiments, the techniques and protocols disclosed herein can also be used for selling multiple ad slots on the same page simultaneously (e.g., three ad slots on the home page for the same time period or overlapping time periods). In some embodiments, the auction of one of the multiple ad slots can affect the auction of one or more of the other multiple ad slots.

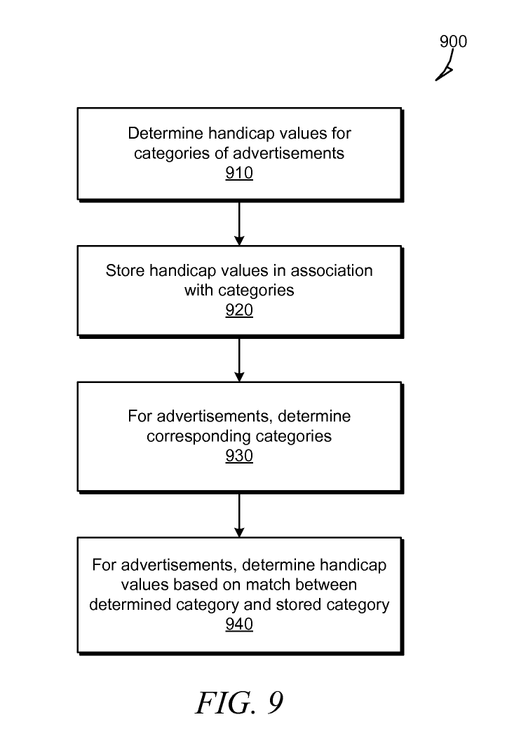

FIG. 9 is a flowchart illustrating a method of online resource allocation, in accordance with some embodiments. The operations of method 900 can be performed by a system or modules of a system. The operations of method 900 can be performed by processing logic that can comprise hardware (e.g., circuitry, dedicated logic, programmable logic, microcode, etc.), software (e.g., instructions run on a processing device), or a combination thereof. In one example embodiment, the method 900 is performed by the resource allocation system 212 of FIGS. 2 and 4, or any combination of one or more of its components or modules, as described above.

At operation 910, corresponding handicap values for each of a plurality of categories of advertisements are determined. In some example embodiments, the determining of the corresponding handicap values comprises performing a machine learning process on advertising information and sales information of a website to determine an effect of advertisements of each one of the plurality of categories on sales of items offered for sale on the website.

At operation 920, the handicap values are stored in a database in association with their corresponding categories,

At operation 930, for each one of the plurality of advertisements, a corresponding category is determined.

At operation 940, for each one of the plurality of advertisements, the corresponding handicap value is determined based on a match between the determined category and one of the stored categories.

It is contemplated that the operations of method 900 can incorporate any of the other features disclosed herein.

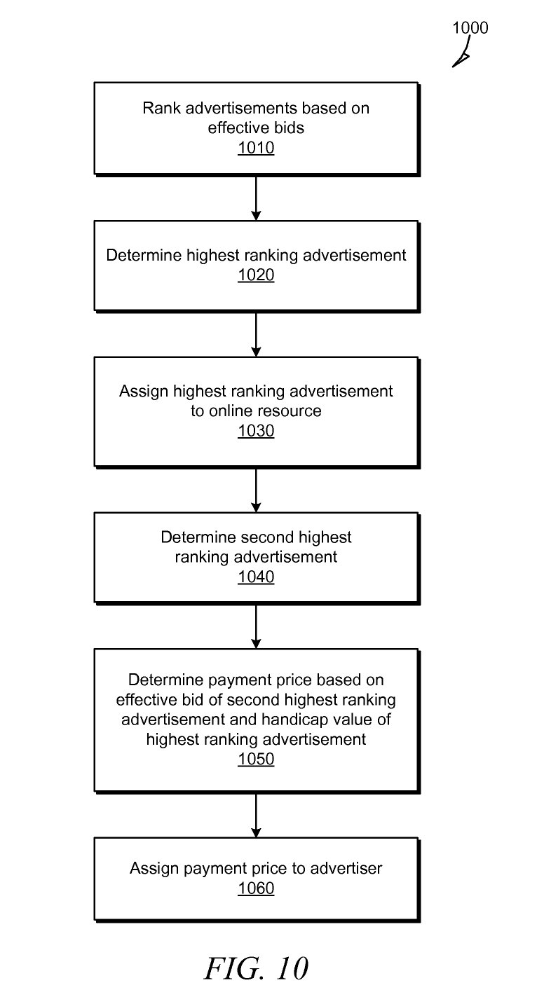

FIG. 10 is a flowchart illustrating a method of online resource allocation, in accordance with some embodiments. The operations of method 1000 can be performed by a system or modules of a system. The operations of method 1000 can be performed by processing logic that can comprise hardware (e.g., circuitry, dedicated logic, programmable logic, microcode, etc.), software (e.g., instructions run on a processing device), or a combination thereof. In one example embodiment, the method 1000 is performed by the resource allocation system 212 of FIGS. 2 and 4, or any combination of one or more of its components or modules, as described above.

At operation 1010, a plurality of advertisements are ranked based on their corresponding effective bids.

At operation 1020, a highest ranking advertisement of the plurality of advertisements is determined.

At operation 1030, the selected one of the plurality of advertisements is assigned to the online resource based on a determination that the selected on is the highest ranking advertisement.

At operation 1040, a second highest ranking advertisement of the plurality of advertisements is determined.

At operation 1050, a payment price for the online resource is determined based on the corresponding effective bid of the second highest ranking advertisement and the corresponding handicap value of the selected one of the plurality of advertisements. In some example embodiments, determining the payment price comprises calculating the sum of the corresponding effective bid of the second highest ranking advertisement and the corresponding handicap value of the selected one of the plurality of advertisements.

At operation 1060, the payment price is assigned, in a database, to the corresponding advertiser of the selected one of the plurality of advertisements.

It is contemplated that the operations of method 1000 can incorporate any of the other features disclosed herein.

It is contemplated that any features of any embodiments disclosed herein can be combined with any other features of any other embodiments disclosed herein. Accordingly, these any such hybrid embodiments are within the scope of the present disclosure.

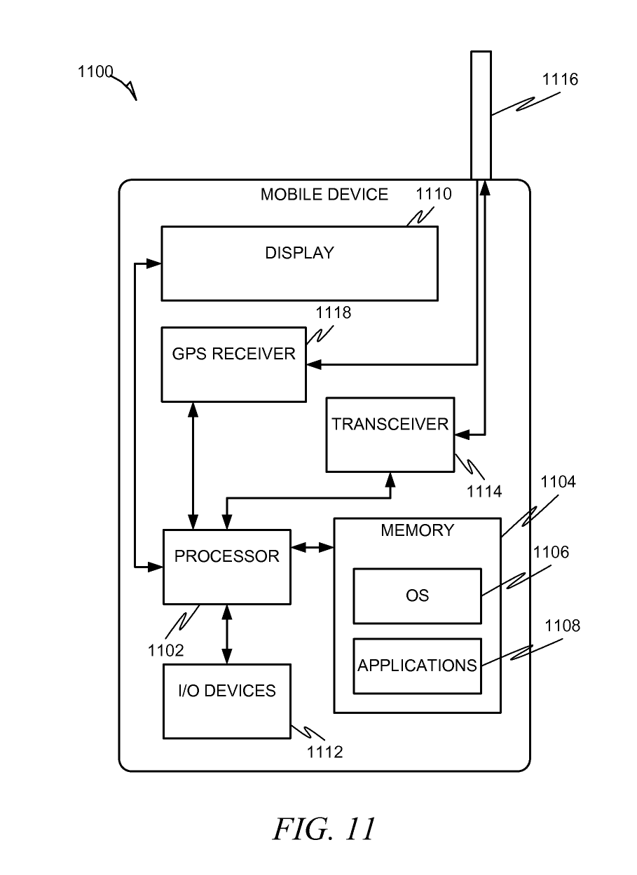

FIG. 11 is a block diagram illustrating a mobile device 1100, according to some example embodiments. The mobile device 1100 can include a processor 1102. The processor 1102 can be any of a variety of different types of commercially available processors suitable for mobile devices 1100 (for example, an XScale architecture microprocessor, a Microprocessor without Interlocked Pipeline Stages (MIPS) architecture processor, or another type of processor). A memory 1104, such as a random access memory (RAM), a Flash memory, or other type of memory, is typically accessible to the processor 1102. The memory 1104 can be adapted to store an operating system (OS) 1106, as well as application programs 1108, such as a mobile location enabled application that can provide LBSs to a user. The processor 1102 can be coupled, either directly or via appropriate intermediary hardware, to a display 1110 and to one or more input/output (I/O) devices 1112, such as a keypad, a touch panel sensor, a microphone, and the like. Similarly, in some example embodiments, the processor 1102 can be coupled to a transceiver 1114 that interfaces with an antenna 1116. The transceiver 1114 can be configured to both transmit and receive cellular network signals, wireless data signals, or other types of signals via the antenna 1116, depending on the nature of the mobile device 1100. Further, in some configurations, a GPS receiver 1118 can also make use of the antenna 1116 to receive GPS signals.

Certain embodiments are described herein as including logic or a number of components, modules, or mechanisms. Modules can constitute either software modules (e.g., code embodied on a machine-readable medium or in a transmission signal) or hardware modules. A hardware module is a tangible unit capable of performing certain operations and can be configured or arranged in a certain manner. In example embodiments, one or more computer systems (e.g., a standalone, client, or server computer system) or one or more hardware modules of a computer system (e.g., a processor or a group of processors) can be configured by software (e.g., an application or application portion) as a hardware module that operates to perform certain operations as described herein.

In various embodiments, a hardware module can be implemented mechanically or electronically. For example, a hardware module can comprise dedicated circuitry or logic that is permanently configured (e.g., as a special-purpose processor, such as a field programmable gate array (FPGA) or an application-specific integrated circuit (ASIC)) to perform certain operations. A hardware module can also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) can be driven by cost and time considerations.

Accordingly, the term “hardware module” should be understood to encompass a tangible entity, be that an entity that is physically constructed, permanently configured (e.g., hardwired) or temporarily configured (e.g., programmed) to operate in a certain manner and/or to perform certain operations described herein. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor can be configured as respective different hardware modules at different times. Software can accordingly configure a processor, for example, to constitute a particular hardware module at one instance of time and to constitute a different hardware module at a different instance of time.

Hardware modules can provide information to, and receive information from, other hardware modules. Accordingly, the described hardware modules can be regarded as being communicatively coupled. Where multiple of such hardware modules exist contemporaneously, communications can be achieved through signal transmission (e.g., over appropriate circuits and buses) that connect the hardware modules. In embodiments in which multiple hardware modules are configured or instantiated at different times, communications between such hardware modules can be achieved, for example, through the storage and retrieval of information in memory structures to which the multiple hardware modules have access. For example, one hardware module can perform an operation and store the output of that operation in a memory device to which it is communicatively coupled. A further hardware module can then, at a later time, access the memory device to retrieve and process the stored output. Hardware modules can also initiate communications with input or output devices and can operate on a resource (e.g., a collection of information).

The various operations of example methods described herein can be performed, at least partially, by one or more processors that are temporarily configured (e.g., by software) or permanently configured to perform the relevant operations. Whether temporarily or permanently configured, such processors can constitute processor-implemented modules that operate to perform one or more operations or functions. The modules referred to herein can, in some example embodiments, comprise processor-implemented modules.

Similarly, the methods described herein can be at least partially processor-implemented. For example, at least some of the operations of a method can be performed by one or more processors or processor-implemented modules. The performance of certain of the operations can be distributed among the one or more processors, not only residing within a single machine, but deployed across a number of machines. In some example embodiments, the processor or processors can be located in a single location (e.g., within a home environment, an office environment or as a server farm), while in other embodiments the processors can be distributed across a number of locations.

The one or more processors can also operate to support performance of the relevant operations in a “cloud computing” environment or as a “software as a service” (SaaS). For example, at least some of the operations can be performed by a group of computers (as examples of machines including processors), these operations being accessible via a network (e.g., the network 104 of FIG. 1) and via one or more appropriate interfaces (e.g., APIs).

Example embodiments can be implemented in digital electronic circuitry, or in computer hardware, firmware, software, or in combinations of them. Example embodiments can be implemented using a computer program product, e.g., a computer program tangibly embodied in an information carrier, e.g., in a machine-readable medium for execution by, or to control the operation of, data processing apparatus, e.g., a programmable processor, a computer, or multiple computers.

A computer program can be written in any form of programming language, including compiled or interpreted languages, and it can be deployed in any form, including as a stand-alone program or as a module, subroutine, or other unit suitable for use in a computing environment. A computer program can be deployed to be executed on one computer or on multiple computers at one site or distributed across multiple sites and interconnected by a communication network.

In example embodiments, operations can be performed by one or more programmable processors executing a computer program to perform functions by operating on input data and generating output. Method operations can also be performed by, and apparatus of example embodiments can be implemented as, special purpose logic circuitry (e.g., a FPGA or an ASIC).

A computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that both hardware and software architectures merit consideration. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware can be a design choice. Below are set out hardware (e.g., machine) and software architectures that can be deployed, in various example embodiments.

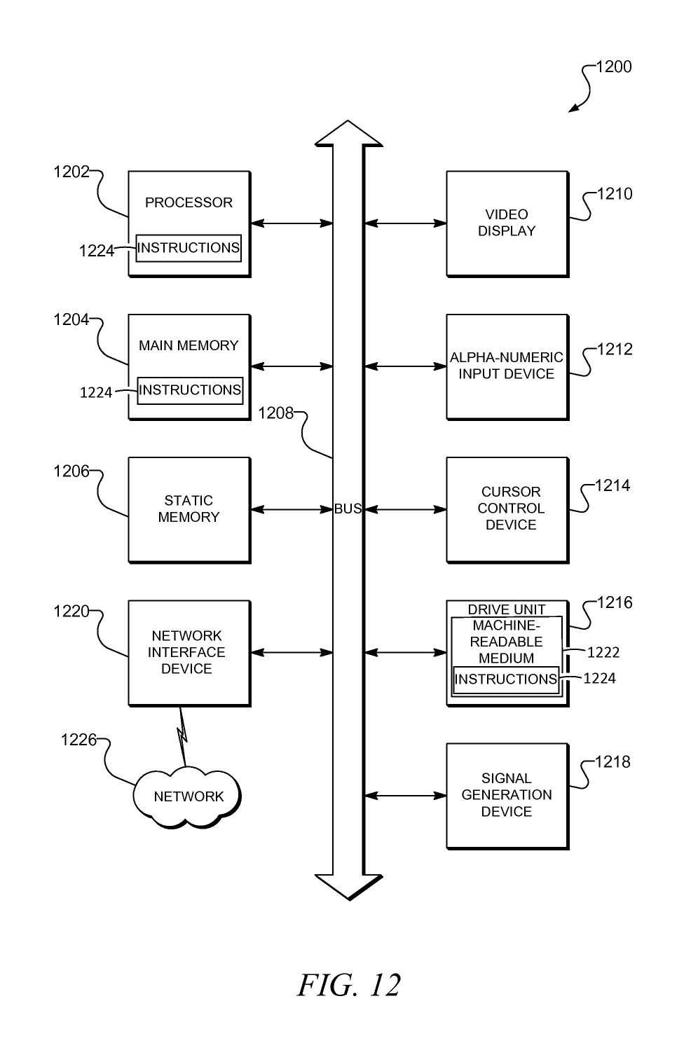

FIG. 12 is a block diagram of a machine in the example form of a computer system 1200 within which instructions for causing the machine to perform any one or more of the methodologies discussed herein can be executed. In alternative embodiments, the machine operates as a standalone device or can be connected (e.g., networked) to other machines. In a networked deployment, the machine can operate in the capacity of a server or a client machine in a server-client network environment, or as a peer machine in a peer-to-peer (or distributed) network environment. The machine can be a personal computer (PC), a tablet PC, a set-top box (STB), a Personal Digital Assistant (PDA), a cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 1200 includes a processor 1202 (e.g., a central processing unit (CPU), a graphics processing unit (GPU) or both), a main memory 1204 and a static memory 1206, which communicate with each other via a bus 1208. The computer system 1200 can further include a video display unit 1210 (e.g., a liquid crystal display (LCD) or a cathode ray tube (CRT)). The computer system 1200 also includes an alphanumeric input device 1212 (e.g., a keyboard), a user interface (UI) navigation (or cursor control) device 1214 (e.g., a mouse), a disk drive unit 1216, a signal generation device 1218 (e.g., a speaker), and a network interface device 1220.

The disk drive unit 1216 includes a machine-readable medium 1222 on which is stored one or more sets of data structures and instructions 1224 (e.g., software) embodying or utilized by any one or more of the methodologies or functions described herein. The instructions 1224 can also reside, completely or at least partially, within the main memory 1204 and/or within the processor 1202 during execution thereof by the computer system 1200, the main memory 1204 and the processor 1202 also constituting machine-readable media. The instructions 1224 can also reside, completely or at least partially, within the static memory 1206.

While the machine-readable medium 1222 is shown in an example embodiment to be a single medium, the term “machine-readable medium” can include a single medium or multiple media (e.g., a centralized or distributed database, and/or associated caches and servers) that store the one or more instructions 1224 or data structures. The term “machine-readable medium” shall also be taken to include any tangible medium that is capable of storing, encoding or carrying instructions for execution by the machine and that cause the machine to perform any one or more of the methodologies of the present embodiments, or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including by way of example semiconductor memory devices (e.g., Erasable Programmable Read-Only Memory (EPROM), Electrically Erasable Programmable Read-Only Memory (EEPROM), and flash memory devices); magnetic disks such as internal hard disks and removable disks; magneto-optical disks; and compact disc-read-only memory (CD-ROM) and digital versatile disc (or digital video disc) read-only memory (DVD-ROM) disks.

The instructions 1224 can further be transmitted or received over a communications network 1226 using a transmission medium. The instructions 1224 can be transmitted using the network interface device 1220 and any one of a number of well-known transfer protocols (e.g., HTTP). Examples of communication networks include a LAN, a WAN, the Internet, mobile telephone networks, POTS networks, and wireless data networks (e.g., WiFi and WiMax networks). The term “transmission medium” shall be taken to include any intangible medium capable of storing, encoding, or carrying instructions for execution by the machine, and includes digital or analog communications signals or other intangible media to facilitate communication of such software.

Although an embodiment has been described with reference to specific example embodiments, it will be evident that various modifications and changes can be made to these embodiments without departing from the broader spirit and scope of the present disclosure. Accordingly, the specification and drawings are to be regarded in an illustrative rather than a restrictive sense. The accompanying drawings that form a part hereof show, by way of illustration, and not of limitation, specific embodiments in which the subject matter can be practiced. The embodiments illustrated are described in sufficient detail to enable those skilled in the art to practice the teachings disclosed herein. Other embodiments can be utilized and derived therefrom, such that structural and logical substitutions and changes can be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter can be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose can be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

What is claimed is:

1. A system comprising:
a processor-implemented bid reception module configured to, for each one of a plurality of advertisements, receive a corresponding original bid for an online resource, each one of the plurality of advertisements corresponding to a different advertiser;
a processor-implemented handicap determination module configured to, for each one of the plurality of advertisements, determine a corresponding handicap value independent of the corresponding original bid;
a processor-implemented effective bid module, executable by the at least one processor, configure to, for each one of the plurality of advertisements, determine a corresponding effective bid for the online resource based on the corresponding original bid and the corresponding handicap value; and
a processor-implemented resource assignment module configured to:
select one of the plurality of advertisements based on the effective bids of the plurality of advertisements;
assign, in a database, the selected one of the plurality of advertisements to the online resource; and
cause the selected one of the plurality of advertisements to be displayed on a computing device in response to a user-generated interrupt received from the computing device.

2. The system of claim 1, wherein the handicap determination module is further configured to:
determine corresponding handicap values for each of a plurality of categories of advertisements, the determining of the corresponding handicap values comprising performing a machine learning process on advertising information and sales information of a website to determine an effect of advertisements of each one of the plurality of categories on sales of items offered for sale on the website;
store the handicap values in the database in association with their corresponding categories; and
determine the corresponding handicap values for each one of the plurality of advertisements by:
for each one of the plurality of advertisements, determining a corresponding category; and
for each one of the plurality of advertisements, determining the corresponding handicap value based on a match between the determined category and one of the stored categories.

3. The system of claim 1, wherein the online resource comprises a single defined advertisement space on a webpage, and causing the selected one of the plurality of advertisements to be displayed on the computing device comprises causing the selected one of the plurality of advertisements to be displayed in the single advertisement space on the webpage.

4. The system of claim 1, wherein the resource assignment module is further configured to:
rank the plurality of advertisements based on their corresponding effective bids;
determine a highest ranking advertisement of the plurality of advertisements, and
assign the selected one of the plurality of advertisements to the online resource based on a determination that the selected on is the highest ranking advertisement.

5. The system of claim 4, further comprising a payment determination module configured to:
determine a second highest ranking advertisement of the plurality of advertisements;
determine a payment price for the online resource based on the corresponding effective bid of the second highest ranking advertisement and the corresponding handicap value of the selected one of the plurality of advertisements; and
assign, in the database, the payment price to the corresponding advertiser of the selected one of the plurality of advertisements.

6. The system of claim 5, wherein the payment determination module is configured to determine the payment price by calculating the sum of the corresponding effective bid of the second highest ranking advertisement and the corresponding handicap value of the selected one of the plurality of advertisements.

7. The system of claim 1, wherein each effective bid is determined based on a subtraction of the corresponding handicap value from the corresponding original bid.

8. A computer-implemented method comprising:
for each one of a plurality of advertisements, receiving a corresponding original bid for an online resource, each one of the plurality of advertisements corresponding to a different advertiser;
for each one of the plurality of advertisements, determining a corresponding handicap value independent of the corresponding original bid;
for each one of the plurality of advertisements, determining, by a machine having a memory and at least one processor, a corresponding effective bid for the online resource based on the corresponding original bid and the corresponding handicap value;
selecting one of the plurality of advertisements based on the effective bids of the plurality of advertisements;
assigning, in a database, the selected one of the plurality of advertisements to the online resource; and
causing the selected one of the plurality of advertisements to be displayed on a computing device in response to a user-generated interrupt received from the computing device.

9. The method of claim 8, further comprising:
determining corresponding handicap values for each of a plurality of categories of advertisements, the determining of the corresponding handicap values comprising performing a machine learning process on advertising information and sales information of a website to determine an effect of advertisements of each one of the plurality of categories on sales of items offered for sale on the website; and
storing the handicap values in the database in association with their corresponding categories,
wherein determining the corresponding handicap values for each one of the plurality of advertisements comprises:
for each one of the plurality of advertisements, determining a corresponding category; and
for each one of the plurality of advertisements, determining the corresponding handicap value based on a match between the determined category and one of the stored categories.

10. The method of claim 8, wherein the online resource comprises a single defined advertisement space on a webpage, and causing the selected one of the plurality of advertisements to be displayed on the computing device comprises causing the selected one of the plurality of advertisements to be displayed in the single advertisement space on the webpage.

11. The method of claim 8, wherein the assigning comprises:
ranking the plurality of advertisements based on their corresponding effective bids;
determining a highest ranking advertisement of the plurality of advertisements, and
assigning the selected one of the plurality of advertisements to the online resource based on a determination that the selected on is the highest ranking advertisement.

12. The method of claim 11, further comprising:
determining a second highest ranking advertisement of the plurality of advertisements;
determining a payment price for the online resource based on the corresponding effective bid of the second highest ranking advertisement and the corresponding handicap value of the selected one of the plurality of advertisements; and
assigning, in the database, the payment price to the corresponding advertiser of the selected one of the plurality of advertisements.

13. The method of claim 12, wherein determining the payment price comprises calculating the sum of the corresponding effective bid of the second highest ranking advertisement and the corresponding handicap value of the selected one of the plurality of advertisements.

14. The method of claim 8, wherein each effective bid is determined based on a subtraction of the corresponding handicap value from the corresponding original bid.

15. A non-transitory machine-readable storage medium storing a set of instructions that, when executed by at least one processor, causes the at least one processor to perform operations comprising:
for each one of a plurality of advertisements, receiving a corresponding original bid for an online resource, each one of the plurality of advertisements corresponding to a different advertiser;
for each one of the plurality of advertisements, determining a corresponding handicap value independent of the corresponding original bid;
for each one of the plurality of advertisements, determining a corresponding effective bid for the online resource based on the corresponding original bid and the corresponding handicap value;
selecting one of the plurality of advertisements based on the effective bids of the plurality of advertisements;
assigning, in a database, the selected one of the plurality of advertisements to the online resource; and
causing the selected one of the plurality of advertisements to be displayed on a computing device in response to a user-generated interrupt received from the computing device.

16. The storage medium of claim 15, wherein the operations further comprise:
determining corresponding handicap values for each of a plurality of categories of advertisements, the determining of the corresponding handicap values comprising performing a machine learning process on advertising information and sales information of a website to determine an effect of advertisements of each one of the plurality of categories on sales of items offered for sale on the website; and
storing the handicap values in the database in association with their corresponding categories,
wherein determining the corresponding handicap values for each one of the plurality of advertisements comprises:
for each one of the plurality of advertisements, determining a corresponding category; and
for each one of the plurality of advertisements, determining the corresponding handicap value based on a match between the determined category and one of the stored categories.

17. The storage medium of claim 15, wherein the online resource comprises a single defined advertisement space on a webpage, and causing the selected one of the plurality of advertisements to be displayed on the computing device comprises causing the selected one of the plurality of advertisements to be displayed in the single advertisement space on the webpage.

18. The storage medium of claim 15, wherein the assigning comprises:
ranking the plurality of advertisements based on their corresponding effective bids;
determining a highest ranking advertisement of the plurality of advertisements, and
assigning the selected one of the plurality of advertisements to the online resource based on a determination that the selected on is the highest ranking advertisement.

19. The storage medium of claim 18, wherein the operations further comprise:
determining a second highest ranking advertisement of the plurality of advertisements;
determining a payment price for the online resource based on the corresponding effective bid of the second highest ranking advertisement and the corresponding handicap value of the selected one of the plurality of advertisements; and
assigning, in the database, the payment price to the corresponding advertiser of the selected one of the plurality of advertisements.

20. The storage medium of claim 19, wherein determining the payment price comprises calculating the sum of the corresponding effective bid of the second highest ranking advertisement and the corresponding handicap value of the selected one of the plurality of advertisements.
